(19) United States
(12) Patent Application Publication
(10) Pub. No.: US 2025/0176529 A1
(43) Pub. Date: Jun. 5, 2025

(54) ELEVATED BAIT STATION

(71) Applicant: SENESTECH INC., Phoenix, AZ (US)

(72) Inventors: Courtney RAY, Gilbert, AZ (US); Dean HEYL, Sun City, AZ (US)

(73) Assignee: SENESTECH INC., Phoenix, AZ (US)

(21) Appl. No.: 18/842,067

(22) PCT Filed: Apr. 3, 2023
(86) PCT No.: PCT/US2023/017308

§ 371 Date: Aug. 28, 2024

Related U.S. Application Data
(60) Provisional application No. 63/331,068, filed on Apr. 14, 2022.

(51) Int. Cl. A01M 25/00; F16M 13/02

(52) U.S. Cl. CPC A01M 25/002; F16M 13/02

(57) ABSTRACT

Aspects of the present disclosure provide an apparatus. For example, the apparatus can include a housing for a bottle with a nozzle to be placed therein, a viewing window installed on the housing, allowing a user to observe a fluid level of a liquid contained in the bottle, one or more screw holes form on the housing, allowing screws to be screwed thereinto to attach the housing to a hook, and a catch basin configured to be placed under the bottle to capture drips or spills while a rodent drinks from the nozzle of the bottle.

### FIELD OF THE PRESENT DISCLOSURE

The present disclosure relates generally to animal feeders/water bottles, and, more particularly, to an elevate bait station for animals.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure

### SUMMARY

Aspects of the present disclosure provide an apparatus. For example, the apparatus can include a housing for a bottle with a nozzle to be placed therein, a viewing window installed on the housing, allowing a user to observe a fluid level of a liquid contained in the bottle, one or more screw holes form on the housing, allowing screws to be screwed thereinto to attach the housing to a book, and a catch basin configured to be placed under the bottle to capture drips or spills while a rodent drinks from the nozzle of the bottle.

In an embodiment, the apparatus further include a bracket configured to attach the housing to a block. For example, the bracket is L-shaped.

Note that this summary section does not specify every embodiment and/or incrementally novel aspect of the present disclosure or claimed disclosure. Instead, this summary only provides a preliminary discussion of different embodiments and corresponding points of novelty over conventional techniques. For additional details and/or possible perspectives of the present disclosure and embodiments, the reader is directed to the Detailed Description section and corresponding figures of the present disclosure as further discussed below.

### BRIEF DESCRIPTION OF THE DRAWINGS

Various embodiments of this disclosure that are proposed as examples will be described in detail with reference to the following figures, wherein like numerals reference like elements, and wherein:

FIGS. 1A to 1U show various isometric views of an exemplary elevate bait apparatus, respectively, in accordance with some embodiments of the present disclosure;

FIGS. 2A to 2C are a side view, a front view and an isometric view of a bracket used for the elevate bait apparatus, respectively, in accordance with some embodiments of the present disclosure;

FIG. 3 is a schematic view illustrating the elevate bait apparatus using two of the brackets to mount to a wood block, in accordance with some embodiments of the present disclosure;

FIGS. 4 and 4A are back views of the elevate bait apparatus showing mounting holes on the back thereof, in accordance with some embodiments of the present disclosure;

FIG. 5 shows a viewing window of the elevate bait apparatus, in accordance with some embodiments of the present disclosure,

FIG. 6 shows a bottle with a long nozzle that can be used for the elevate bait apparatus, in accordance with some embodiments of the present disclosure;

FIGS. 7A to 7E are a side view, a front view, two isometric views and a top view of a hook used for the elevate bait apparatus, respectively, in accordance with some embodiments of the present disclosure;

FIG. 8 are various views of a catch basin used for the elevate bait apparatus in accordance with some embodiments of the present disclosure;

FIGS. 9A and 9B are a cross-sectional view and the specification of a stopper, respectively, that can be included on the bottle, in accordance with some embodiments of the present disclosure; and

FIGS. 10 and 11 show the components of the elevate bait apparatus in accordance with some embodiments of the present disclosure.

### DETAILED DESCRIPTION

The word “exemplary” is used herein to mean, “serving as an example, instance or illustration.” Any embodiment of construction, process, design, technique, etc., designated herein as exemplary is not necessarily to be construed as preferred or advantageous over other such embodiments. Particular quality or fitness of the examples indicated herein as exemplary is neither intended nor should be inferred.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the apparatus (or device) in use or operation in addition to the orientation depicted in the figures. The apparatus (or device) may be otherwise oriented (rotated 90 degrees or at other orientations) and the spatially relative descriptors used herein may likewise be interpreted accordingly.

The order of discussion of the different steps as described herein has been presented for clarity sake. In general, these steps can be performed in any suitable order. Additionally, although each of the different features, techniques, configurations, etc. herein may be discussed in different places of the present disclosure, it is intended that each of the concepts can be executed independently of each other or in combination with each other. Accordingly, the present disclosure can be embodied and viewed in many different ways.

According to some aspects of the present disclosure, an above-ground elevate bait apparatus that can house a removable bottle to supply a liquid presented by a long nozzle.

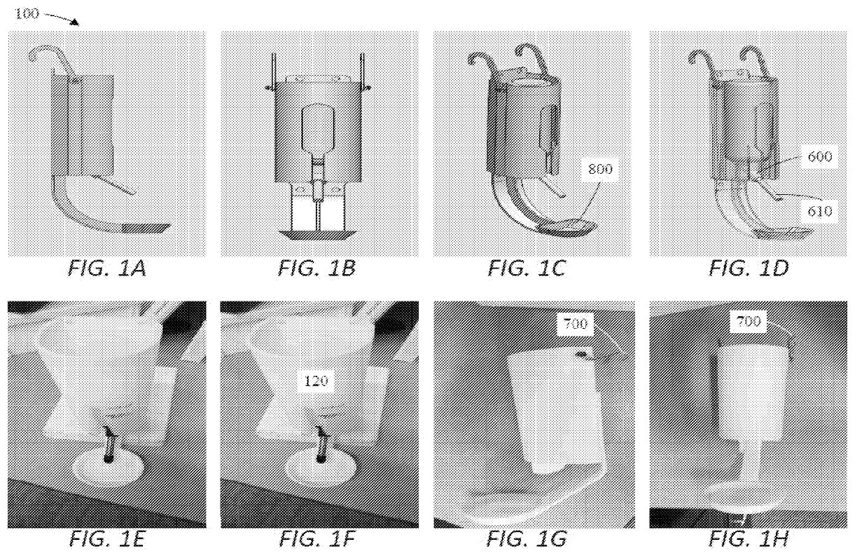

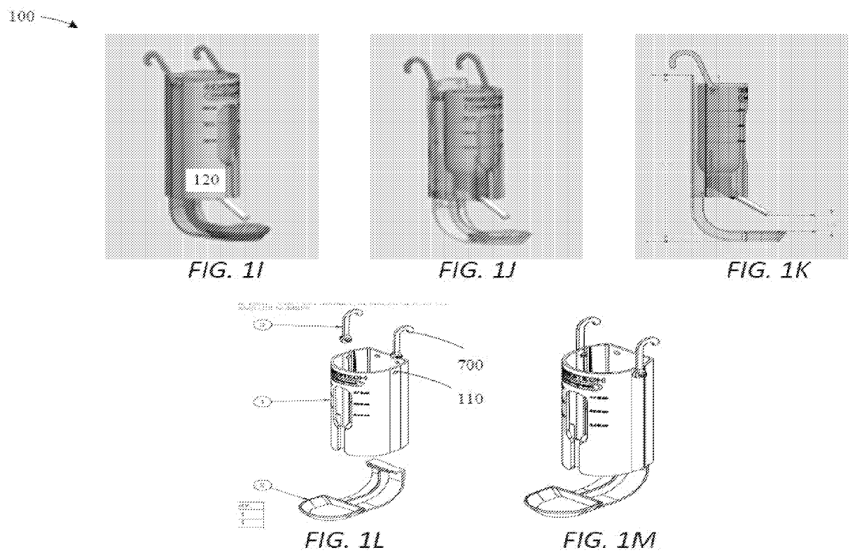

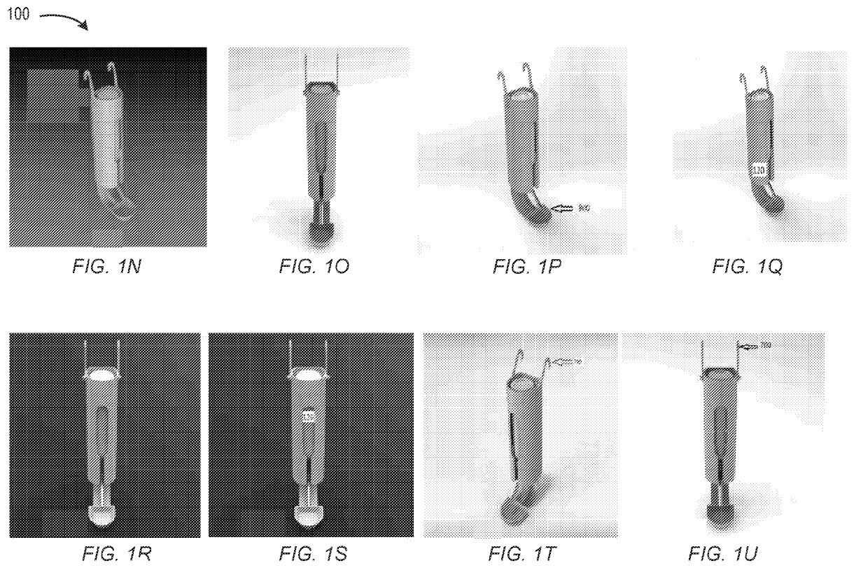

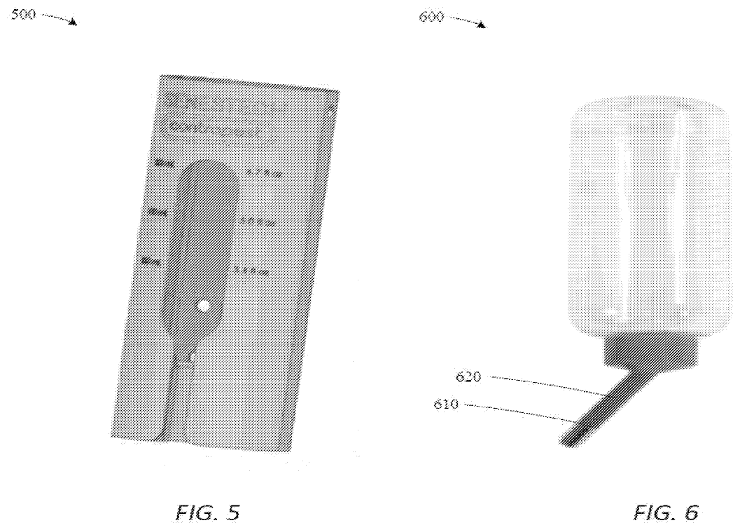

FIGS. 1A to 1U show various isometric views of an exemplary elevate bait apparatus 100, respectively, in accordance with some embodiments of the present disclosure. The elevate bait apparatus 100 can be mounted in many different manners. The elevate bait apparatus 100 can include a housing 120 for a bottle 600 (shown in FIG. 6) to be placed therein.

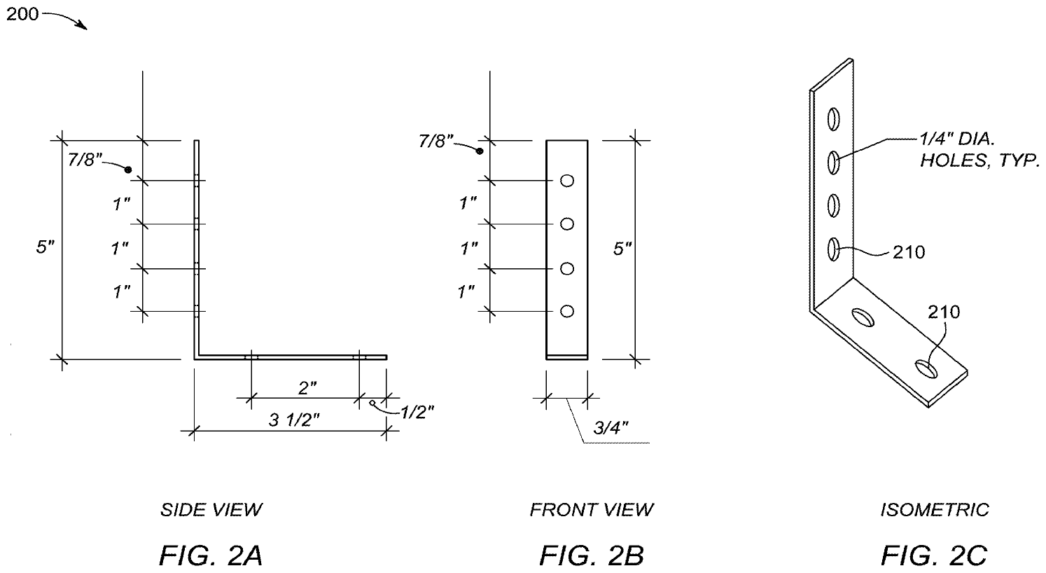

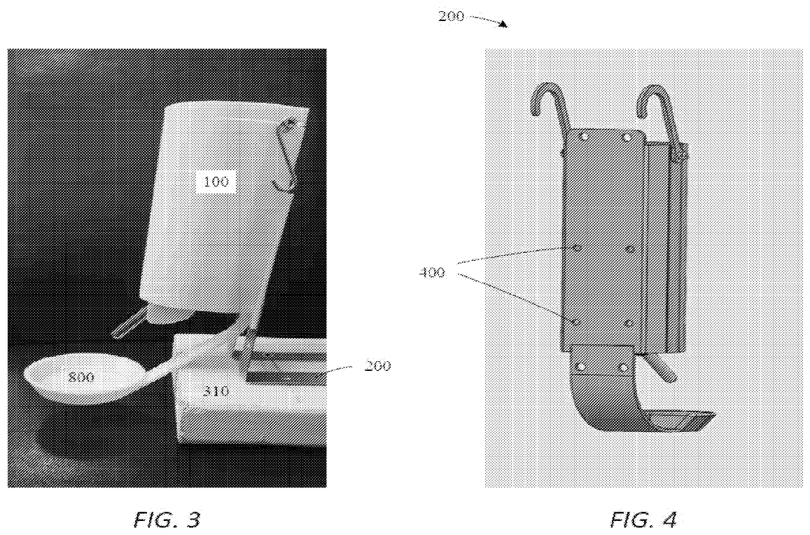

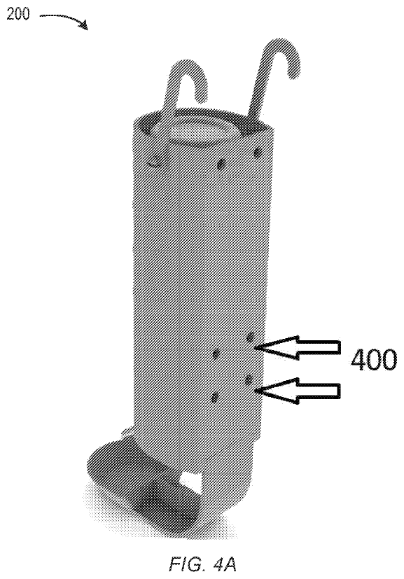

FIGS. 2A to 2C are a side view, a front view and an isometric view of a bracket 200 used for the elevate bait apparatus 100 shown in FIGS. 1A to IM, respectively, in accordance with some embodiments of the present disclosure. The bracket 200 can be L-shaped. The bracket 200 can be attached to a block 310, e.g., a wood block, as shown in FIG. 3, to mount the elevate bait apparatus 100 to a ledge, a wall or a rafter (not shown). For example, the bracket 200 can include one or more bracket holes 210 on each of the extension parts of the L-shape. A cable, a screw, or a zip tie such as a plastic zip tie, can be used to pass through the bracket hole 210 of the bracket 200 and one of a plurality of mounting holes 400 of the elevate bait apparatus 100 (shown in FIG. 4) so as to attach the elevate bait apparatus 100 to the ledge, the wall or the rafter.

FIG. 3 is a schematic view illustrating the elevate bait apparatus 100 using two of the brackets 200 to mount to the wood block 310, in accordance with some embodiments of the present disclosure.

FIGS. 4 and 4A are back views of the elevate bait apparatus 100 showing the mounting holes 400 on the back thereof, in accordance with some embodiments of the present disclosure.

FIG. 5 shows a viewing window 500 of the elevate bait apparatus 100, in accordance with some embodiments of the present disclosure. The viewing window 500 allows a user to observe the fluid level in the bottle 600. For example, the fluid level has graduations and is represented along the sides of the viewing window 500 in fl., oz., and/or ml. The fluid contained in the bottle 600 has a milky white color, for example, and, therefore, there is a color contrast between the viewing window 500 and the color of the elevate bait apparatus 100.

FIG. 6 shows the bottle 600 with a long nozzle 610 that can be used for the elevate bait apparatus 100, in accordance with some embodiments of the present disclosure. In an embodiment, the bottle 600 can be placed in the housing 120 of the elevate bait apparatus 100, as shown in FIG. 1D, for supplying a liquid presented by the long nozzle 610. The long nozzle 610 can maintain the liquid in a tube 620 of the bottle 600 by a ball.

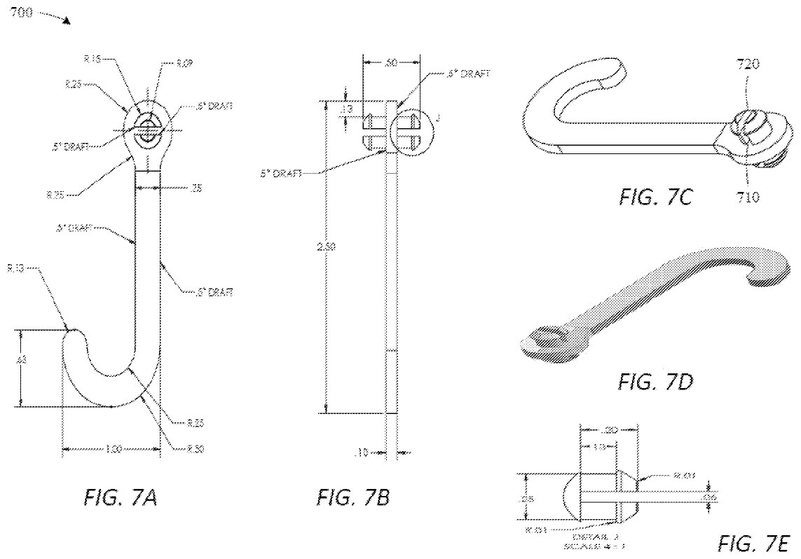

FIGS. 7A to 7E are a side view, a front view, two isometric views and a top view of a hook 700 used for the elevate bait apparatus 100, respectively, in accordance with some embodiments of the present disclosure. The hook 700 can be made of plastic. The hook 700 can be utilized to hang the elevate bait apparatus 100, as shown in FIGS. 1G and 1H. The hook 700 can include a hook hole 710, and a screw 720 can be used to pass through the hook hole 710 and a corresponding screw hole 110 (shown in FIG. 1L) of the elevate bait apparatus 100 to attach the elevate bait apparatus 100 to a rafter, for example.

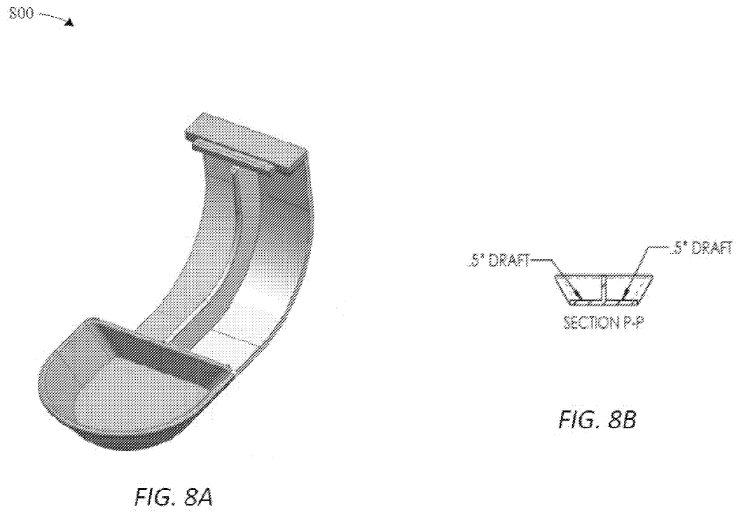

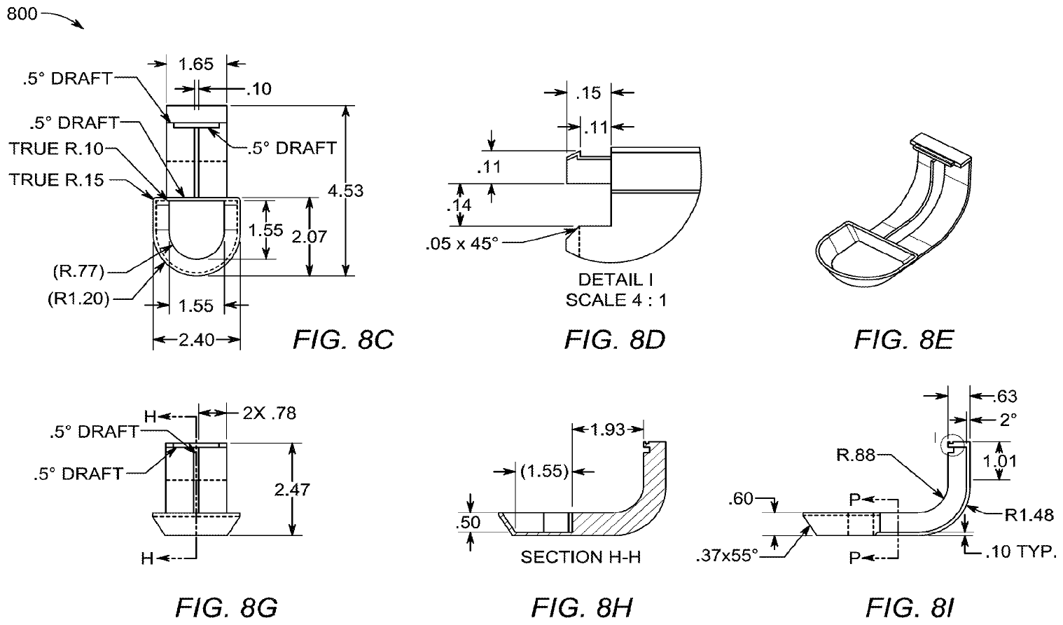

FIG. 8 are various views of a catch basin 800 used for the elevate bait apparatus 100 in accordance with some embodiments of the present disclosure. The catch basin 800 can be included in the elevate bait apparatus 100, and designed to be disposed under and aligned with the bottle 600, specifically, the long nozzle 610, in order to capture drips or spills while the rodents drink from the long nozzle 610, as shown in FIGS. 1C and 3. The catch basin 800 can retain approximately 20 ml of liquid, for example.

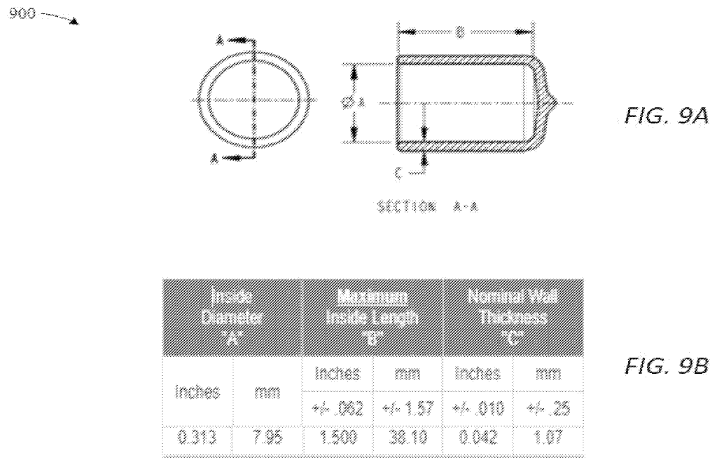

FIGS. 9A and 9B are a cross-sectional view and the specification of a stopper 900, respectively, that can be included on the bottle 600, in accordance with some embodiments of the present disclosure. The stopper 900 can be included on the long nozzle 610 to keep the liquid contained while presenting the bottle 600 into the elevate bait apparatus 100. The stopper 900 can be removed when the elevate bait apparatus 100 is secured, the bottle 600 has been prepared, and the liquid is ready for pest consumption.

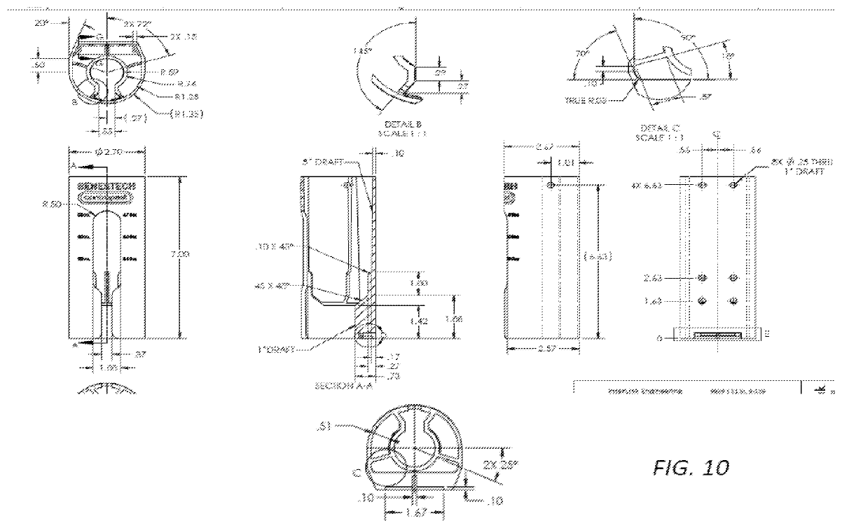

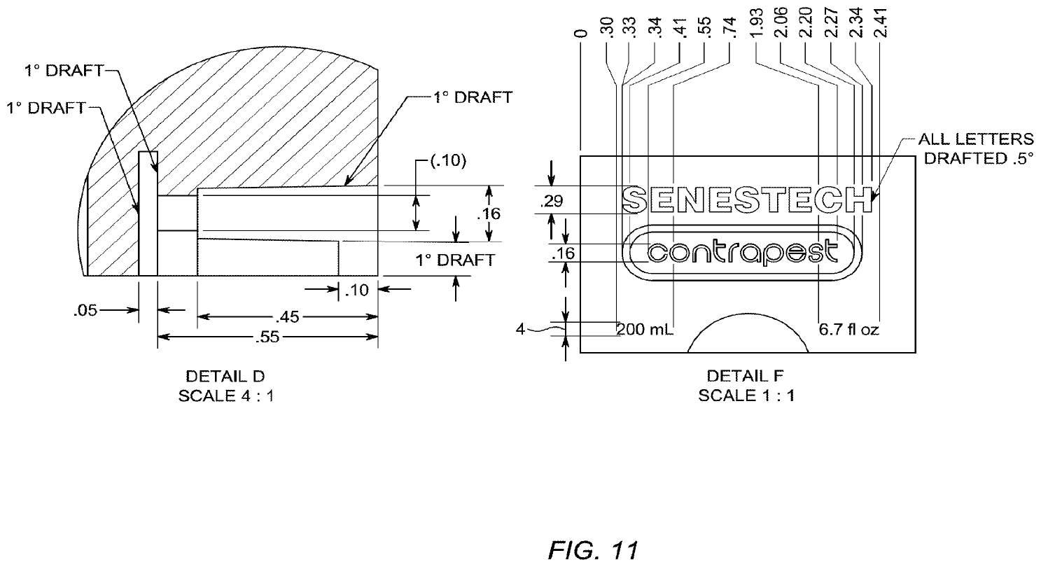

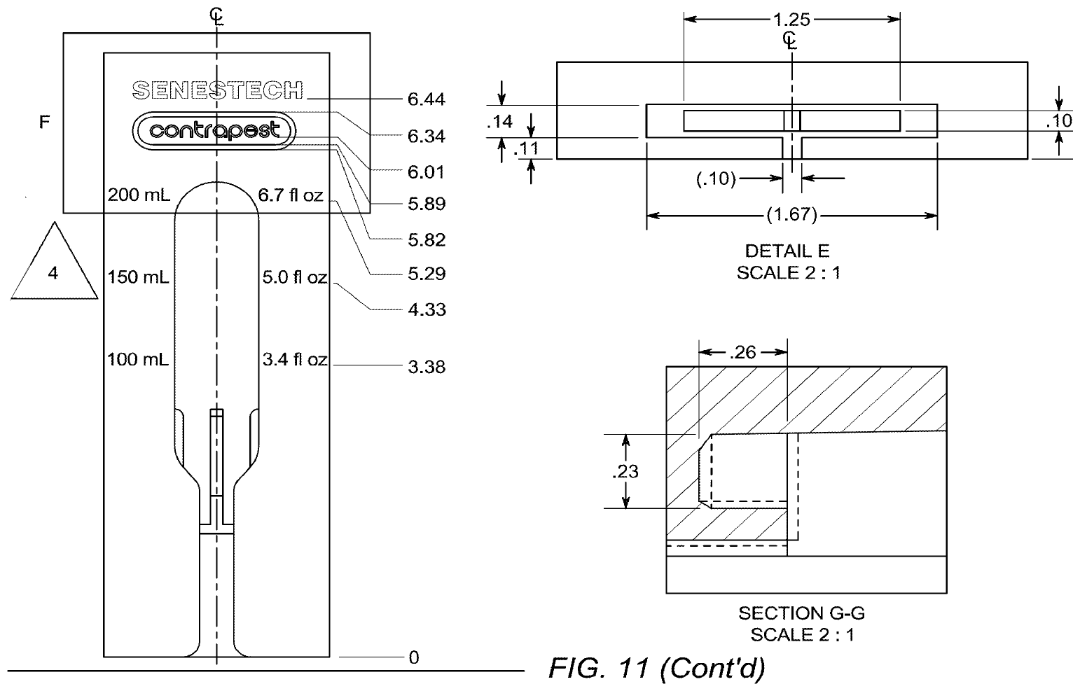

FIGS. 10 and 11 show the components of the elevate bait apparatus in accordance with some embodiments of the present disclosure.

Those skilled in the art will also understand that there can be many variations made to the operations of the techniques explained above while still achieving the same objectives of the present disclosure. Such variations are intended to be covered by the scope of this disclosure. As such, the foregoing descriptions of embodiments of the present disclosure are not intended to be limiting. Rather, any limitations to embodiments of the present disclosure are presented in the following claims.

What is claimed is:

1. An apparatus, comprising:
a housing for a bottle with a nozzle to be placed therein;
a viewing window installed on the housing, allowing a user to observe a fluid level of a liquid contained in the bottle;
one or more screw holes form on the housing, allowing screws to be screwed thereinto to attach the housing to a hook; and
a catch basin configured to be placed under the bottle to capture drips or spills while a rodent drinks from the nozzle of the bottle.

2. The apparatus of claim 1, further comprising:
a bracket configured to attach the housing to a block.

3. The apparatus of claim 2, wherein the bracket is L-shaped.
